(19) United States
(12) Patent Application Publication
(10) Pub. No.: US 2020/0208820 A1
(43) Pub. Date: Jul. 2, 2020

(54) Lamp Bulb and Dedicated Non-Contact Assembling and Disassembling Tool Thereof

(71) Applicant: Yong Xu, Zhejiang (CN)

(72) Inventor: Yong Xu, Zhejiang (CN)

(21) Appl. No.: 16/632,417

(22) PCT Filed: Mar. 31, 2018
(86) PCT No.: PCT/CN2018/081493

§ 371 Date: Jan. 20, 2020

(30) Foreign Application Priority Data
Jul. 28, 2017 (CN) 201710629413.X

(51) Int. Cl. F21V 21/36; F21V 19/04

(52) U.S. Cl. CPC F21V 21/36; B25B 27/14; F21V 19/04

(57) ABSTRACT

A light bulb, comprising a light bulb body (1); at least one connector protrusion (12) is provided on the outer circumference of the light bulb body (1), the connector protrusions (12) being arranged at intervals on the light bulb body (1) or distributed in a radial shape with respect to the center of the light bulb body (1); the connector protrusions (12) cooperate with a dedicated assembling and disassembling tool during light bulb replacement, realizing non-contact and remote assembling and disassembling of light bulbs, achieving the characteristics of safe assembly and disassembly, a simple and practical structure and low maintenance cost.

### TECHNICAL FIELD

The disclosure relates to a lamp bulb, in particular to a lamp bulb and a dedicated non-contact assembling and disassembling tool of the lamp bulb.

### BACKGROUND

Lamp bulb is one of necessary accessories for modern lighting, regardless of high or low quality, it always has a certain service life, and after the lamp bulb is damaged, in order to ensure the illumination brightness, the lamp bulb must be replaced manually.

Traditional lamp bulbs (comprising buckle joint lamp bulbs or threaded joint lamp bulbs or plug-in type lamp bulbs) are free of the arrangement of a structure convenient to disassemble and assemble or the allocation of a dedicated assembling and disassembling tool, and operators are directly used for holding the lamp bulbs for operation during replacement.

Moreover, in practice, after the lamp bulb is damaged, it is difficult for people to confirm whether the switch is on or off, when the lamp bulb is replaced, hands are easily in contact with the metal part of the lamp bulb to cause an electric shock, even the explosion of the lamp bulb, and great potential safety hazards exist.

Moreover, for an energy-saving lamp bulb as shown in FIG. 1, the part grasped with hands during replacement is a spiral glass body 1′, the glass body 1′ is easy to get loosened with a lamp holder 2′ during replacement to cause that the lamp bulb is damaged, or even cause that the glass body 1′ is damaged to scratch double hands in severe conditions.

Moreover, for a plug-in type halogen lamp bulb 3′ as shown in FIG. 2, the plug-in type halogen lamp bulb is small in volume, high in power and extremely high in heat productivity, and if the plug-in type halogen lamp bulb operates in an electrification condition, high temperature can be generated once the lamp bulb is plugged, and the phenomenon of scorching fingers is extremely easy to occur.

Moreover, the above contact type lamp bulb replacement enables an operator to must be in contact with the lamp bulb and operate the lamp bulb in a short-distance environment, however, in practice, due to the limitation of a building structure, the installation position of the lamp bulb does not have a standard height and distance, especially for lighting or street lamp lighting of some factories, the installation height of the lamp bulb is at least several meters, and the lamp bulb must be operated by means of equipment such as a cloud ladder when being replaced, so that the operation is inconvenient, the maintenance cost is high, the disassembly and assembly efficiency is low, a great potential safety hazard exists in high-altitude operation, and the operator has the risk of falling from a high place in the climbing process.

### SUMMARY

Aiming at the problems, the disclosure designs a lamp bulb and a dedicated non-contact assembling and disassembling tool thereof, wherein a clamping connection structure convenient for assembly and disassembly is arranged on the existing lamp bulb structure, the lamp bulb is combined with a dedicated assembling and disassembling tool when the lamp bulb is replaced, so that non-contact and remote assembly and disassembly of lamp bulbs can be realized, and the lamp bulb has the characteristics of safe assembly and disassembly, simple and practical structure and low maintenance cost.

In order to achieve the above purpose, the disclosure adopts the following technical scheme:

A lamp bulb comprising a lamp bulb body is characterized in that at least one connecting protruding strip is arranged on the outer circumference of the lamp bulb body, the connecting protruding strips are arranged at intervals on the lamp bulb body or distributed in a radial shape relative to the center of the lamp bulb body.

Further, the outer end of each connecting protruding strip exceeds the circumference where the maximum outer diameter of the lamp bulb body is located.

Further, the connecting protruding strips are directly integrally formed with the lamp bulb body.

Further, the connecting protruding strips are installed on a clamping ring, the connecting protruding strips and the clamping ring are of an integrated structure, a plurality of buckles are arranged in the clamping ring, and the buckles can be connected with corresponding clamping grooves in the outer circumference of the lamp bulb body in a clamping mode.

Further, the connecting protruding strips are installed on the clamping ring, the connecting protruding strips and the clamping ring are of a split combined structure, an external thread is arranged on the inner end of each connecting protruding strip, the inner end of each connecting protruding strip is in threaded connection with a threaded hole at a corresponding position on the clamping ring, and the inner ends of the connecting protruding strips can stretch into the clamping ring and are supported on the outer wall of the lamp bulb body through the rotation of the connecting protruding strips relative to the threaded holes.

Further, the connecting protruding strips are installed on an adapter, the connecting protruding strips and the adapter are integrally formed, the lower part of the adapter is in threaded connection or clamping connection or insertion connection with a connector of the lamp bulb body, and a threaded connector or a clamping connector or an insertion connector is arranged on the top of the adapter.

Further, a connector is directly arranged at the upper end of the lamp bulb body or an inner groove is formed in the upper end of the lamp bulb body, a connector is arranged in the inner groove, the connector is connected with a lamp holder with an internal thread, and the outer diameter of the lamp holder is smaller than the inner diameter of the inner groove.

Further, a protruding stop flange is arranged on the top of each connecting protruding strip.

A dedicated assembling and disassembling tool comprises a connecting base, a plurality of connecting forks are arranged in the periphery of the connecting base along the circumferential direction in a uniformly-spaced mode, a clamping groove is formed in the top of each connecting fork, the clamping grooves are the same in structures, the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

Further, the lower part of the connecting base is connected with a plurality of connecting rods through straight cutting structures or quick connectors, and the connecting rods are connected together through the straight cutting structures or the quick connectors.

The dedicated assembling and disassembling tool comprises a circular connecting sleeve, a plurality of clamping grooves are formed in the top of the connecting sleeve along the circumferential direction at intervals, the clamping grooves are the same in structures, the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

Further, a connector is arranged below or on the side wall of the connecting sleeve, the connector is connected with a plurality of connecting rods through straight cutting structures or quick connectors, and the connecting rods are connected together through the straight cutting structures or the quick connectors.

The dedicated assembling and disassembling tool comprises a connecting base, the head of the connecting base is provided with a plurality of radiation guide rails distributed in the radial shape relative to the center, each radiation guide rail is provided with a clamping rod capable of sliding along the inside and outside of each radiation guide rail, a locking nut is arranged at the joint of each clamping rod and the corresponding radiation guide rail, a clamping groove is formed in the top of each clamping rod, the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

Further, a connector is arranged below the connecting sleeve, the connector is connected with a plurality of connecting rods through straight cutting structures or quick connectors, and the connecting rods are connected together through the straight cutting structures or the quick connectors.

The dedicated assembling and disassembling tool comprises a connecting base, a plurality of connecting forks are arranged at the upper end of the connecting base around the circumferential direction in the uniformly-spaced mode, notch clamping grooves are formed in the connecting forks in the same peripheral direction, and the arrangement heights of the notch clamping grooves are the same.

Further, a connector is arranged below the connecting sleeve, the connector is connected with a plurality of connecting rods through straight cutting structures or quick connectors, and the connecting rods are connected together through the straight cutting structures or the quick connectors.

The connecting protruding strips distributed in parallel or in the radial shape are arranged on the outer circumference of the lamp bulb body in the lamp bulb, the connecting protruding strips can be connected with the clamping grooves or the notch clamping grooves in the dedicated assembling and disassembling tool in the clamping mode to realize effective locking of the connecting protruding strips and the clamping grooves or the notch clamping grooves, and then the lamp bulb is driven to synchronously rotate or pull down through the rotation of the assembling and disassembling tool so as to realize the assembly and disassembly of the lamp bulb.

The connecting protruding strips of the whole lamp bulb are very simple in structure improvement and very low in improvement cost, but excellent technical and using effects can be achieved, and the risk of an electric shock in the replacement process can be completely eradicated fundamentally through the non-contact and remote assembly and disassembly of the dedicated tool, so that the lamp bulb has the characteristics of safe assembly and disassembly, simple and practical structure and low maintenance cost.

### BRIEF DESCRIPTION OF THE DRAWINGS

FIG. 1 is a stereoscopic structure diagram of an existing energy-saving lamp bulb;

FIG. 2 is a stereoscopic structure diagram of an existing halogen small lamp bulb;

FIG. 3 is a stereoscopic structure diagram of the lamp bulb;

FIG. 4 is a stereoscopic structure diagram of connecting protruding strips distributed in parallel in the disclosure;

FIG. 5 is a second embodiment of the connecting protruding strips in the disclosure;

FIG. 6 is a third embodiment of the connecting protruding strips in the disclosure;

FIG. 7 is a fourth embodiment of the connecting protruding strips in the disclosure;

FIG. 8 is a stereoscopic structure diagram of the fourth embodiment of the connecting protruding strips used in the small lamp bulb in the disclosure;

FIG. 9 is a stereoscopic structure diagram of an inner groove formed in the top of the lamp bulb body in the disclosure;

FIG. 10 is a stereoscopic structure diagram of a dedicated assembling and disassembling tool in the disclosure;

FIG. 11 is a stereoscopic structure diagram of a connecting base with connecting rods in FIG. 10 in the disclosure;

FIG. 12 is a structure diagram of the connecting base and the lamp bulb during package and transportation in the disclosure;

FIG. 13 is a second embodiment of the dedicated assembling and disassembling tool in the disclosure;

FIG. 14 is a stereoscopic structure diagram of a connecting sleeve in FIG. 13 and the lamp bulb during clamping in the disclosure;

FIG. 15 is a third embodiment of the dedicated assembling and disassembling tool in the disclosure;

FIG. 16 is a fourth embodiment of the dedicated assembling and disassembling tool in the disclosure;

FIG. 17 is a stereoscopic structure diagram of clamping rods in FIG. 16 and the lamp bulb during clamping in the disclosure;

FIG. 18 is a fifth embodiment of the dedicated assembling and disassembling tool in the disclosure;

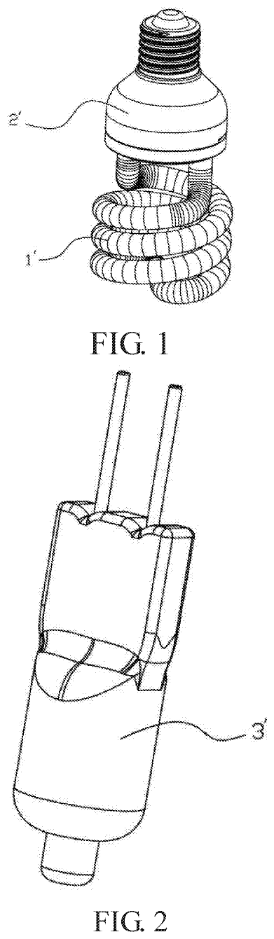

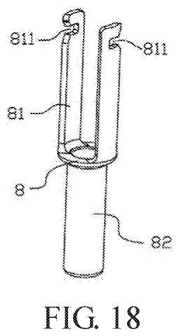

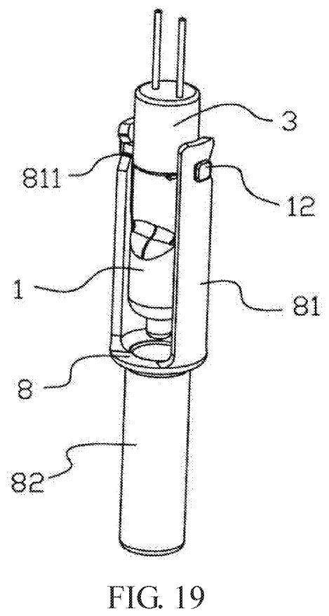

and FIG. 19 is a stereoscopic structure diagram of connecting forks in FIG. 18 and the lamp bulb during clamping in the disclosure.

### DESCRIPTION OF THE EMBODIMENTS

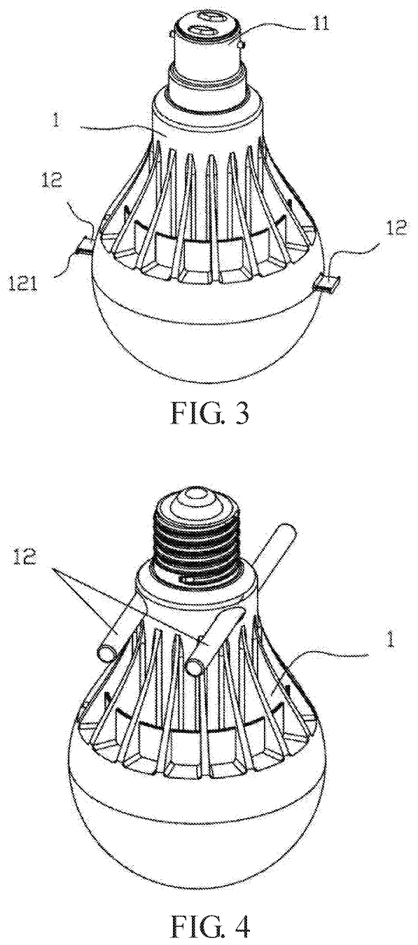

As shown in FIG. 3, a lamp bulb convenient for remote assembly and disassembly comprises a lamp bulb body 1, the top end of the lamp bulb body 1 is provided with a buckle type connector 11, and a threaded connector or a plug-in connector can also be used in practice.

At least one connecting protruding strip 12 is arranged on the outer circumference of the lamp bulb body 1. The number of the connecting protruding strips 12 set in FIG. 3 is two, and one or three or more connecting protruding strips can be set according to requirements in practice.

The connecting protruding strips 12 are arranged on the lamp bulb body 1 at intervals or distributed relative to the center of the lamp bulb body 1 in a radial shape. As shown in FIG. 3, the connecting protruding strips 12 are distributed in the radial shape, and considering stress uniformity, the connecting protruding strips 12 are distributed along the circumferential direction at intervals uniformly.

As shown in FIG. 4, the connecting protruding strips 12 are of an arranged layout structure.

Here, In order to achieve effective clamping of each connecting protruding strip 12 and the dedicated tool, the outer end of each connecting protruding strip 12 exceeds the circumference where the maximum outer diameter of the lamp bulb body 1 is located, and a stop flange 121 is arranged on the top of each connecting protruding strip 12.

The light source type of the lamp bulb is not limited, and energy-saving lamps, LED lamps and halogen lamps are all suitable.

There are various connection types of the connecting protruding strips 12 and the lamp bulb body 1, and as shown in FIG. 4, the connecting protruding strips 12 are directly integrally formed with the lamp bulb body 1. However, there are some relatively common connecting structures in practice, which are described further below respectively.

As shown in FIG. 5, the connecting protruding strips 12 on the lamp bulb body 1 are installed on a clamping ring 13, the connecting protruding strips 12 and the clamping ring 13 are of an integrated structure, a plurality of buckles 131 are arranged in the clamping ring 13, and the buckles 131 can be connected with corresponding clamping grooves 14 in the outer circumference of the lamp bulb body 1 in a clamping mode. When in use, clamping connection is realized between the connecting protruding strips 12 and the lamp bulb body 1 through the buckles 131 in the clamping ring 13.

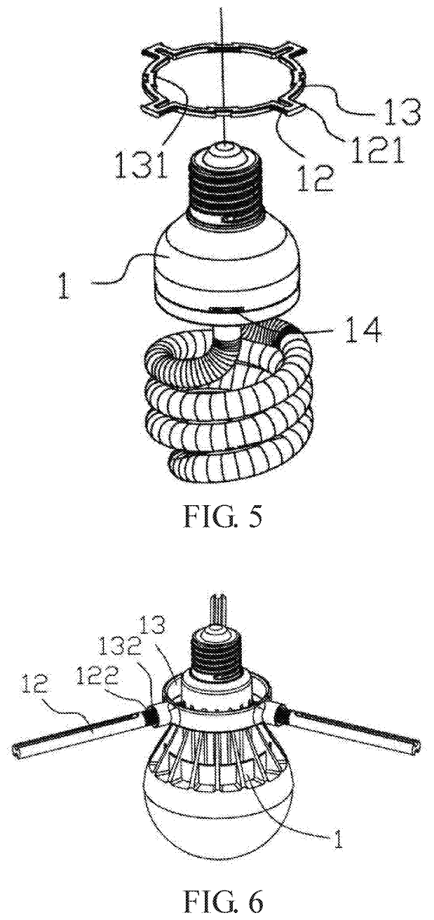

As shown in FIG. 6, the connecting protruding strips 12 are installed on the clamping ring 13 as well, the connecting protruding strips 12 and the clamping ring 13 are of a split combined structure, an external thread 122 is arranged on the inner end of each connecting protruding strip 12, the inner end of each connecting protruding strip is in threaded connection with a threaded hole 132 at a corresponding position on the clamping ring 13, and the inner ends of the connecting protruding strips 12 can stretch into the clamping ring 13 and are supported on the outer wall of the lamp bulb body 1 through the rotation of the connecting protruding strips 12 relative to the threaded holes 132. The arrangement of the structure is directly used for modification and use of an existing traditional lamp bulb structure, and the locking connection of various outer diameter specifications of lamp bulb bodies 1 can be realized through internal and external telescopic structures of the connecting protruding strips 12 relative to the clamping rings 13.

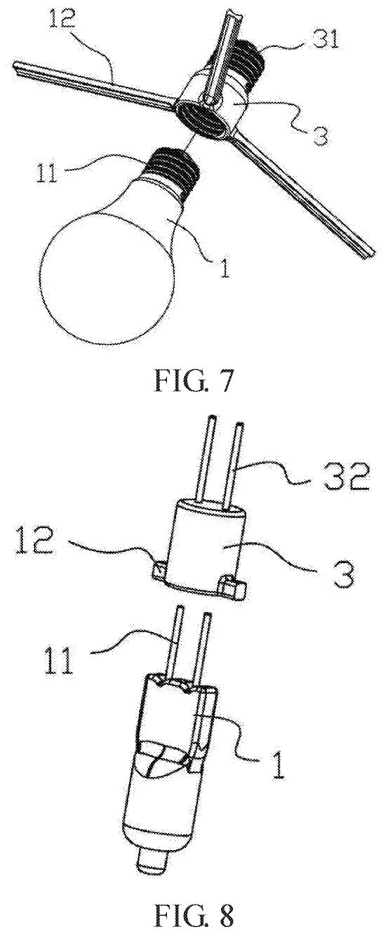

However, as shown in FIG. 7 and FIG. 8, the connecting protruding strips 12 are installed on an adapter 3, the connecting protruding strips 12 and the adapter 3 are integrally formed, the lower part of the adapter 3 is in threaded connection or clamping connection or insertion connection with a connector 11 of the lamp bulb body 1, and a threaded connector 31 or a clamping connector or an insertion connector 32 is arranged on the top of the adapter 3. The arrangement of the structure is directly used for modification and use of the existing traditional lamp bulb structure, and a corresponding clamping structure can be added without changing the structure of the existing lamp bulb at all.

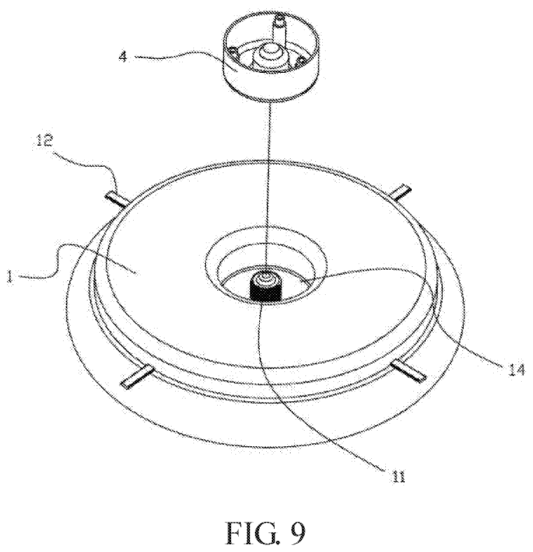

Here, the upper end of the lamp bulb body 1 is directly provided with a protruding connector 11 used for connection with a lamp holder, but in practice, the connector structure cannot be used in the tops of some ceiling lamp bulbs, thus, as shown in FIG. 9, an inner groove 14 is formed in the upper end of the lamp bulb body 1, a connector 11 is arranged in the inner groove 14, the connector 11 is connected with the lamp holder 4 with an internal thread, and the outer diameter of the lamp holder 4 is smaller than the inner diameter of the inner groove 14. Through the arrangement of the structure, the lamp holder 4 can completely enter into the inner groove 14 when the lamp holder 4 is connected with the lamp bulb body 11 so as to realize seamless ceiling installation on the top of the lamp bulb body 1.

In order to achieve non-contact installation and remote assembly and disassembly of the lamp bulb provided with the connecting protruding strip structures, a dedicated tool needs to be configured.

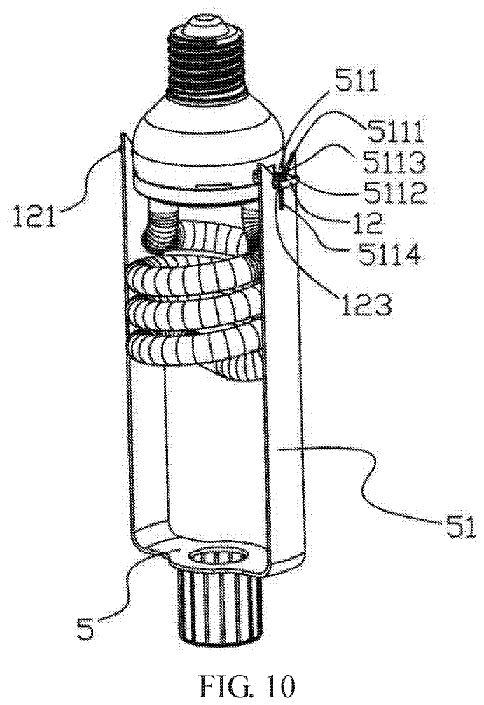

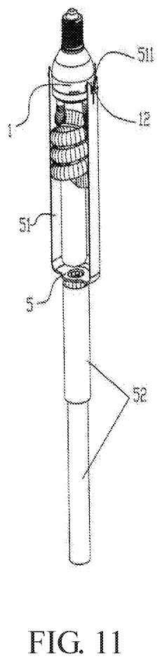

As shown in FIG. 10, a dedicated assembling and disassembling tool of the lamp bulb comprises a connecting base 5, and a plurality of connecting forks 51 are arranged on the periphery of the connecting base 5 along the circumferential direction in a uniformly-spaced mode. Here, considering package and transportation cost, the structures of two connecting forks 51 as shown in FIG. 10 are in a preferable embodiment, and the arrangement of more connecting forks also can be adopted according to requirements in practice.

A clamping groove 511 is formed in the top of each connecting fork 51, the clamping grooves 511 are the same in structures, the upper part of each clamping groove 511 is arranged into a V-shaped structure 5111, a preferable guiding role can be achieved when the clamping grooves 511 are in butt joint with the connecting protruding strips 12, moreover, arc chamfers 123 or bevel chamfers are arranged on two sides of the lower part of each connecting protruding strip 12, and the butt joint guiding of the clamping grooves 511 and the connecting protruding strips 12 is facilitated as well.

A locking groove 5112 is formed in the lower part of each clamping groove 511, the size of each locking groove 5112 is larger than the width of the corresponding connecting protruding strip 12, and the connecting part of each locking groove 5112 and the corresponding V-shaped structure 5111 protrudes outwards to form a limiting protrusion 5113. When in use, once the connecting protruding strips 12 extrude and get over the limiting protrusions 5113 to enter into the locking grooves 5112, the connecting protruding strips 12 are difficult to separate, effective locking of the connecting protruding strips 12 and the locking grooves 5112 can be realized, and the problem that the lamp bulb is separated to fall off in the moving process of the dedicated assembling and disassembling tool is avoided. Here, in order to further guarantee the locking effectiveness of the connecting protruding strips 12 and the locking grooves 5112, a protruding stop flange 121 is arranged on the top of each connecting protruding strip 12 so as to realize effective restriction of the connecting protruding strips 12 and the connecting forks 51.

During disassembling, the clamping grooves 511 in the connecting forks align to the corresponding connecting protruding strips 12 on the lamp bulb body 1 to be clamped until the connecting protruding strips 12 get over the limiting protrusions 5113 to enter into the locking grooves 5112, and then the lamp bulb can be driven to synchronously rotate by rotating the connecting base 5 with hands so as to realize replacement operation. The above whole replacement process is performed through the connecting base 5, and the hands are not in direct contact with the lamp bulb to realize non-contact replacement, on one hand, the lamp bulb cannot be damaged, and on the other hand, the lamp bulb is free of an electric shock risk, so that the lamp bulb has the characteristics of safe assembly and disassembly and simple and practical structure.

Moreover, for the purpose that the deformability of an opening of the whole clamping groove 511 can be increased so that the connecting protruding strips 12 get over the limiting protrusion 5113 conveniently in a labor-saving mode, an opening crack 5114 is arranged at the bottom of each clamping groove 511.

As shown in FIG. 11, considering some requirements of remote or high-altitude replacement in practice, the lower part of the connecting base 5 is connected with connecting rods 52 through straight cutting structures or quick connectors, only the straight cutting structures are illustrated in FIG. 11, and the technology of the quick connector structures is extremely mature and is not described here. A plurality of connecting rods 52 can be set according to requirements, and the connecting rods 52 are connected together through the straight cutting structures or the quick connectors as well. When in use, remote or high-altitude replacement of the lamp bulb can be realized through the connecting base when an operator stands on the ground through the connecting extension of each connecting rod 52, and the lamp bulb has the characteristics of simple and convenient operation and safe replacement.

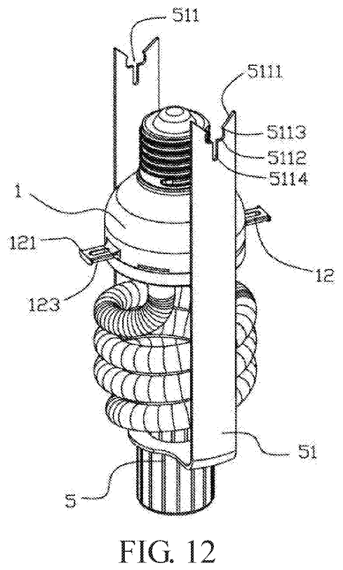

Moreover, during packaging, the whole lamp bulb can be directly placed into two forks of the connecting base 5, as shown in FIG. 12, the packaging volume of the lamp bulb cannot be increased basically, the package and transportation cost can be reduced effectively, and meanwhile, the connecting forks 51 also can play a preferable protective effect on the lamp bulb, especially an energy-saving lamp bulb, in the transportation process.

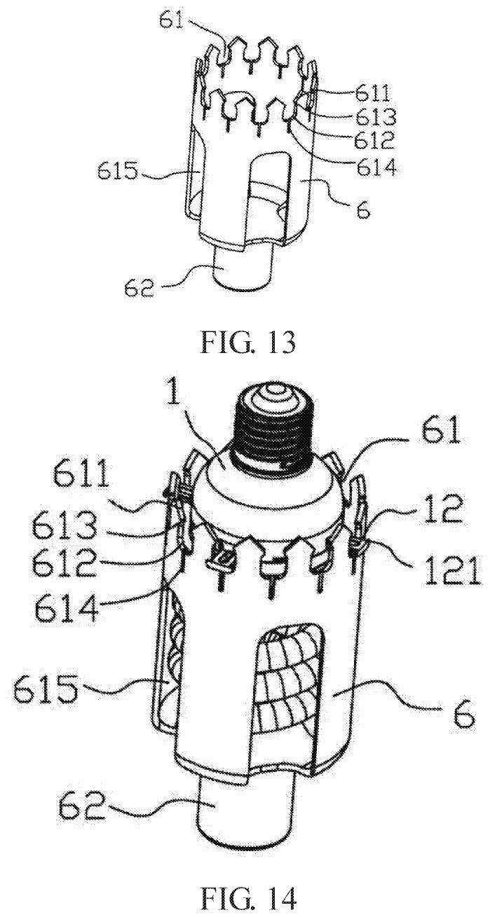

As shown in FIG. 13 and FIG. 14, a second dedicated assembling and disassembling tool of the lamp bulb comprises a circular connecting sleeve 6.

A plurality of clamping grooves 61 are formed in the top of the connecting sleeve 6 along the circumferential direction at intervals, the number of the clamping grooves 61 set in FIG. 13 and FIG. 14 is twelve, and the number of the corresponding clamping grooves 61 is set according to requirements in practice. Moreover, in order to meet the assembly and disassembly requirements of various specifications of lamp bulbs, the clamping grooves 61 are distributed around the circumferential direction equally at intervals, and the assembly and disassembly requirements of the lamp bulb on the numbers of one, two, three, four, six, nine and twelve connecting protruding strips 12 can be met.

The upper part of each clamping groove 61 is arranged into a V-shaped structure 611, a preferable guiding role can be achieved when the clamping grooves 611 are in butt joint with the connecting protruding strips 12, moreover, arc chamfers or bevel chamfers are arranged on two sides of the lower part of each connecting protruding strip 12, and the butt joint guiding of the clamping grooves 611 and the connecting protruding strips 12 is facilitated as well.

A locking groove 612 is formed in the lower part of each clamping groove 61, the size of each locking groove 612 is larger than the width of the corresponding connecting protruding strip 12, and the connecting part of each locking groove 612 and the corresponding V-shaped structure 611 protrudes outwards to form a limiting protrusion 613. When in use, once the connecting protruding strips 12 extrude and get over the limiting protrusions 613 to enter into the locking grooves 612, the connecting protruding strips 12 are difficult to separate, effective locking of the connecting protruding strips 12 and the locking grooves 612 can be realized, and the problem that the lamp bulb is separated to fall off in the moving process of the dedicated assembling and disassembling tool is avoided. Here, in order to further guarantee the locking effectiveness of the connecting protruding strips 12 and the locking grooves 612, a protruding stop flange 121 is arranged on the top of each connecting protruding strip 12 so as to realize effective restriction of the connecting protruding strips 12 and the connecting sleeve 6.

Moreover, for the purpose that the deformability of an opening of the whole clamping groove 61 can be increased so that the connecting protruding strips 12 get over the limiting protrusion 613 conveniently in the labor-saving mode, an opening crack 614 is arranged at the bottom of each clamping groove 61. Meanwhile, due to the fact that the lower part of the connecting sleeve 61 does not play a role in operation, the lower part of the connecting sleeve 61 is provided with a plurality of hollowed-out structures 615, materials can be reduced, and meanwhile, the state of the lamp bulb can be conveniently observed in use.

During disassembling, the clamping grooves 61 in the connecting sleeve 6 align to the corresponding connecting protruding strips 12 on the lamp bulb body to be clamped until the connecting protruding strips 12 get over the limiting protrusions 613 to enter into the locking grooves 612, and then the lamp bulb can be driven to synchronously rotate by rotating the connecting sleeve with hands so as to realize replacement operation. The above whole replacement process is performed through the connecting sleeve 6, and the hands are not in direct contact with the lamp bulb in the whole replacement process to realize non-contact replacement, on one hand, the lamp bulb cannot be damaged, and on the other hand, the lamp bulb is free of an electric shock risk, so that the lamp bulb has the characteristics of safe assembly and disassembly and simple and practical structure.

Here, considering some requirements of remote or high-altitude replacement in practice, the lower part of the connecting sleeve is connected with a connector 62, the connector is connected with connecting rods through quick connectors or straight cutting structures, and the connecting rods are connected together through the quick connectors or the straight cutting structures. When in use, a corresponding number of connecting rods are connected according to the actual assembling and disassembling distance of the lamp bulb.

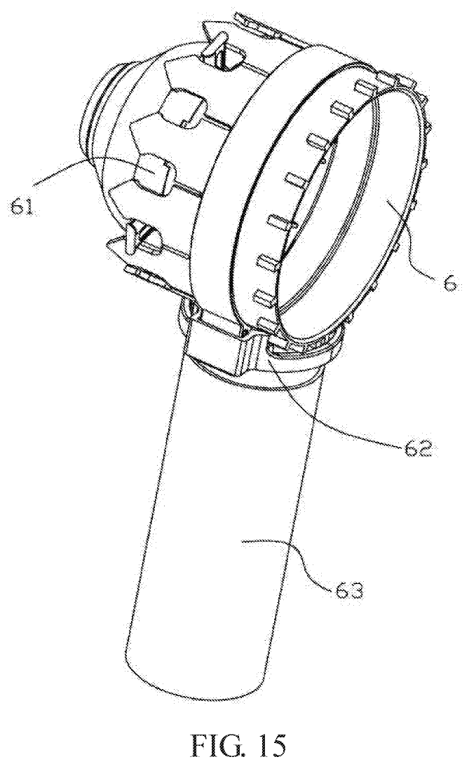

Mover, as shown in FIG. 15, a third dedicated tool of the lamp bulb is illustrated, the structure of the connecting sleeve 6 is the same as that of the second dedicated tool, but a connector 62 is arranged on the side wall of the connecting sleeve 6, the connector 62 is connected with connecting rods 63 through the quick connectors or the straight cutting structures, and the connecting rods 63 are connected together through the quick connectors or the straight cutting structures. Through the arrangement of the structure, the clamping grooves 61 in the connecting sleeve 6 and the connecting rods 62 are arranged at certain angles so as to meet the multi-angle assembly and disassembly requirement of the lamp bulb in practice.

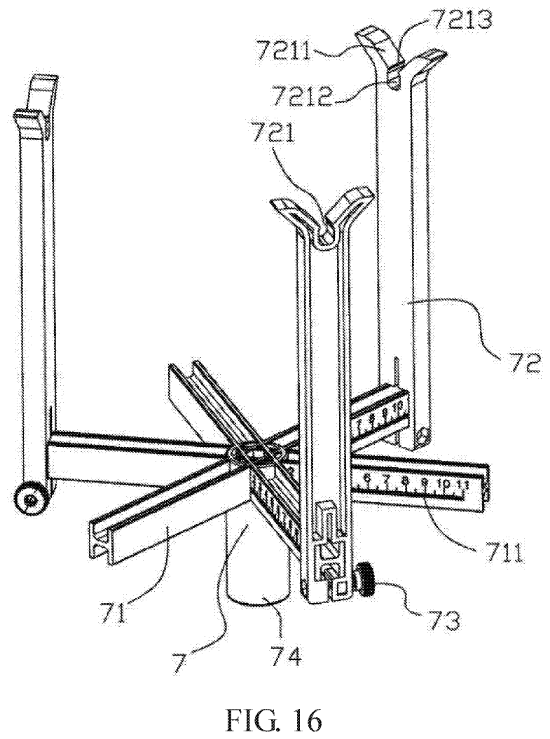

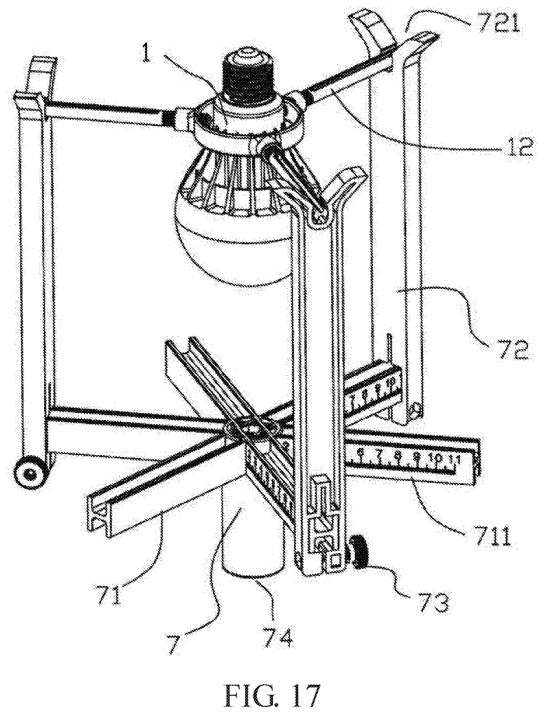

Moreover, as shown in FIG. 16 and FIG. 17, a fourth dedicated assembling and disassembling tool of the lamp bulb comprises a connecting base 7.

The head of the connecting base 7 is provided with a plurality of radiation guide rails 71 distributed in the radial shape relative to the center, the number of the radiation guide rails 71 set in FIG. 16 and FIG. 17 is six, and the corresponding number is set according to requirements in practice.

Each radiation guide rail 71 is provided with a clamping rod 72 capable of sliding along the inside and outside of each radiation guide rail. When in use, the positions of the clamping rods 72 relative to the radiation guide rails 71 are adjusted according to the specification and dimension of the lamp bulb body so as to achieve an optimal clamping effect with the connecting protruding strips 12. Moreover, for the requirement of facilitating to adjust the inner and outer positions of the clamping rods 72, scale dimensions 711 are arranged on each radiation guide rail 71. A locking nut 73 is arranged at the joint of each clamping rod 72 and the corresponding radiation guide rail 71 so as to realize effective locking of the clamping rods 72 after being adjusted in place.

A clamping groove 721 is formed in the top of each clamping rod 72. The upper part of each clamping groove 721 is arranged into a V-shaped structure 7211, a preferable guiding role can be achieved when the clamping grooves 72 are in butt joint with the connecting protruding strips 12, moreover, arc chamfers or bevel chamfers are arranged on two sides of the lower part of each connecting protruding strip 12, and the butt joint guiding of the clamping grooves 721 and the connecting protruding strips 12 is facilitated as well.

A locking groove 7212 is formed in the lower part of each clamping groove 721, the size of each locking groove 7212 is larger than the width of the corresponding connecting protruding strip 12, and the connecting part of each locking groove 7212 and the corresponding V-shaped structure 7211 protrudes outwards to form a limiting protrusion 7213. When in use, once the connecting protruding strips 12 extrude and get over the limiting protrusions 7213 to enter into the locking grooves 7212, the connecting protruding strips 12 are difficult to separate, effective locking of the connecting protruding strips 12 and the locking grooves 712 can be realized, and the problem that the lamp bulb is separated to fall off in the moving process of the dedicated assembling and disassembling tool is avoided. Here, in order to further guarantee the locking effectiveness of the connecting protruding strips 12 and the locking grooves 712, a protruding stop flange 121 is arranged on the top of each connecting protruding strip 12 so as to realize effective restriction of the connecting protruding strips 12 and the connecting sleeve 7.

A connector 74 is arranged below the connecting base 7, the connector 74 is connected with the connecting rods through straight cutting structures or quick connectors, and the connecting rods are connected together through the straight cutting structures or the quick connectors.

As shown in FIG. 18 and FIG. 19, a fifth dedicated assembling and disassembling tool of the lamp bulb is arranged aiming at a plug-in type lamp bulb mainly. The dedicated assembling and disassembling tool comprises a connecting base 8, a plurality of connecting forks 81 are arranged at the upper end of the connecting base 8 around the circumferential direction in the uniformly-spaced mode, notch clamping grooves 811 are formed in the connecting forks 81 in the same peripheral direction, and the arrangement heights of the notch clamping grooves 811 are the same.

The number of the connecting forks 81 set in FIG. 18 and FIG. 19 is two, and three or more connecting forks can be set according to requirements in practice.

When in use, firstly a gap between every two adjacent connecting forks 81 aligns to a corresponding connecting protruding strip 12 of the lamp bulb to be inserted until the height of the corresponding notch clamping groove 811 is almost equal to that of the corresponding connecting protruding strip 12, then, the corresponding connecting protruding strip 12 is clamped into the corresponding clamping groove 811 of the corresponding connecting fork by rotating the connecting base 8, and then the connecting base 8 is pulled down, so that the connecting base 8 can be disassembled from the lamp holder along with the lamp bulb. During installation, firstly, the lamp bulb with the connecting protruding strips 12 is clamped into the clamping grooves 811 of the connecting forks, then, the lamp bulb is inserted into the lamp holder by pushing up the connecting base 8, and finally the connecting protruding strips 12 come out of the clamping grooves 811 by reversely rotating the connecting base 8 so as to realize separation of the connecting protruding strips 12 and the clamping grooves 811. The above whole assembling and disassembling process is a non-contact operation mode as well, an electric shock cannot occur, and a scalding phenomenon also cannot occur.

Similarly, in order to achieve the requirement of remote installation, a connector 82 is arranged below the connecting base 8, the connector 82 is connected with a plurality of connecting rods through straight cutting structures or quick connectors, and the connecting rods are connected together through the straight cutting structures or the quick connectors.

Above all, the connecting protruding strips 12 distributed in parallel or in the radial shape are arranged on the outer circumference of the lamp bulb body 1 in the lamp bulb, the connecting protruding strips 12 can be connected with the clamping grooves or the notch clamping grooves in the dedicated assembling and disassembling tool in the clamping mode to realize effective locking of the connecting protruding strips 12 and the clamping grooves or the notch clamping grooves, and then the lamp bulb is driven to synchronously rotate or directly pull down and push up through the rotation of the assembling and disassembling tool so as to realize the assembly and disassembly of the lamp bulb.

The connecting protruding strips 12 of the above lamp bulb 1 are very simple in structure improvement and very low in improvement cost, but excellent technical and using effects can be achieved, and the risk of an electric shock in the replacement process can be completely eradicated fundamentally through the non-contact and remote assembly and disassembly of the dedicated tool, so that the lamp bulb has the characteristics of safe assembly and disassembly, simple and practical structure and low maintenance cost.

Above all, the foregoing descriptions are merely exemplary embodiments of the disclosure, but are not limitation of the disclosure in any form. Any simple modification, equivalent change, or modification made for the embodiments according to the technical principle of the disclosure shall fall within the scope of the technical proposal of the disclosure.

1. A lamp bulb, comprising a lamp bulb body, characterized in that at least one connecting protruding strip is arranged on the outer circumference of the lamp bulb body, the connecting protruding strips are arranged at intervals on the lamp bulb body or distributed in a radial shape relative to the center of the lamp bulb body.

2. The lamp bulb according to claim 1, characterized in that the connecting protruding strips are directly integrally formed with the lamp bulb body.

3. The lamp bulb according to claim 1, characterized in that the connecting protruding strips are installed on a clamping ring, the connecting protruding strips and the clamping ring are of an integrated structure, a plurality of buckles are arranged in the clamping ring, and the buckles can be connected with corresponding clamping grooves in the outer circumference of the lamp bulb body in a clamping mode.

4. The lamp bulb according to claim 1, characterized in that the connecting protruding strips are installed on the clamping ring, the connecting protruding strips and the clamping ring are of a split combined structure, an external thread is arranged on the inner end of each connecting protruding strip, the inner end of each connecting protruding strip is in threaded connection with a threaded hole at a corresponding position on the clamping ring, and the inner ends of the connecting protruding strips can stretch into the clamping ring and are supported on the outer wall of the lamp bulb body through the rotation of the connecting protruding strips relative to the threaded holes.

5. The lamp bulb according to claim 1, characterized in that the connecting protruding strips are installed on an adapter, the connecting protruding strips and the adapter are integrally formed, the lower part of the adapter is in threaded connection or clamping connection or insertion connection with a connector of the lamp bulb body, and a threaded connector or a clamping connector or an insertion connector is arranged on the top of the adapter.

6. The lamp bulb according to claim 1, characterized in that a connector is directly arranged at the upper end of the lamp bulb body or an inner groove is formed in the upper end of the lamp bulb body, a connector is arranged in the inner groove, and the connector is connected with a lamp holder with an internal thread.

7. The lamp bulb according to claim 6, characterized in that the outer diameter of the lamp holder is smaller than the inner diameter of the inner groove.

8. The lamp bulb according to claim 1, characterized in that a protruding stop flange is arranged on the top of each connecting protruding strip.

9. The lamp bulb according to claim 1, characterized in that the outer end of each connecting protruding strip exceeds the circumference where the maximum outer diameter of the lamp bulb body is located.

10. A dedicated assembling and disassembling tool according to claim 1, characterized by comprising a connecting base, wherein a plurality of connecting forks are arranged in the periphery of the connecting base along the circumferential direction in a uniformly-spaced mode, and a clamping groove is formed in the top of each connecting fork.

11. The dedicated assembling and disassembling tool according to claim 10, characterized in that the clamping grooves in the connecting forks are the same in structures, the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

12. The dedicated assembling and disassembling tool according to claim 10, characterized in that the lower part of the connecting base is connected with a plurality of connecting rods through straight cutting structures or quick connectors, and the connecting rods are connected together through the straight cutting structures or the quick connectors.

13. The dedicated assembling and disassembling tool according to claim 1, characterized by comprising a circular connecting sleeve, wherein a plurality of clamping grooves are formed in the top of the connecting sleeve along the circumferential direction at intervals.

14. The dedicated assembling and disassembling tool according to claim 13, characterized in that the clamping grooves in the connecting sleeve are the same in structures, the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

15. The dedicated assembling and disassembling tool according to claim 13, characterized in that a connector is arranged below or on the side wall of the connecting sleeve, the connector is connected with a plurality of connecting rods through straight cutting structures or quick connectors, and the connecting rods are connected together through the straight cutting structures or the quick connectors.

16. The dedicated assembling and disassembling tool according to claim 1, characterized by comprising a connecting base, wherein the head of the connecting base is provided with a plurality of radiation guide rails distributed in the radial shape relative to the center, each radiation guide rail is provided with a clamping rod capable of sliding along the inside and outside of each radiation guide rail, a locking nut is arranged at the joint of each clamping rod and the corresponding radiation guide rail, and a clamping groove is formed in the top of each clamping rod.

17. The dedicated assembling and disassembling tool according to claim 16, characterized in that the upper part of each clamping groove is arranged into a V-shaped structure, a locking groove is formed in the lower part of each clamping groove, the size of each locking groove is larger than the width of the corresponding connecting protruding strip, and the connecting part of each locking groove and the corresponding V-shaped structure protrudes outwards to form a limiting protrusion.

18. The dedicated assembling and disassembling tool according to claim 16, characterized in that a connector is arranged below the connecting sleeve, the connector is connected with a plurality of connecting rods through straight cutting structures or quick connectors, and the connecting rods are connected together through the straight cutting structures or the quick connectors.

19. The dedicated assembling and disassembling tool according to claim 1, characterized by comprising a connecting base, wherein a plurality of connecting forks are arranged at the upper end of the connecting base around the circumferential direction in the uniformly-spaced mode, notch clamping grooves are formed in the connecting forks in the same peripheral direction, and the arrangement heights of the notch clamping grooves are the same.

20. The dedicated assembling and disassembling tool according to claim 19, characterized in that a connector is arranged below the connecting base, the connector is connected with a plurality of connecting rods through straight cutting structures or quick connectors, and the connecting rods are connected together through the straight cutting structures or the quick connectors.
